(19) United States
(12) Patent Application Publication
(10) Pub. No.: US 2012/0327371 A1
(43) Pub. Date: Dec. 27, 2012

(54) LASER LIGHT SOURCE APPARATUS

(75) Inventors: Yuichi HATASE, Fukuoka (JP); Tomohiro MATSUO, Fukuoka (JP); Kenji NAKAYAMA, Kumamoto (JP); Kohei SUYAMA, Fukuoka (JP)

(73) Assignee: PANASONIC CORPORATION, Osaka (JP)

(21) Appl. No.: 13/364,660

(22) Filed: Feb. 2, 2012

(30) Foreign Application Priority Data
Jun. 27, 2011 (JP) 2011-142110

(51) Int. Cl. G03B 21/14; F21V 9/16

(52) U.S. Cl. 353/31; 362/84

(57) ABSTRACT

Provided is a laser light source apparatus capable of maintaining a favorable level of laser output and inhibiting a margin for optical axis adjustment required for other optical elements. The present invention includes: a semiconductor laser emitting excitation laser light; a laser medium excited by the excitation laser light and emitting infrared laser light; a wavelength conversion element converting a wavelength of the infrared laser light and emitting harmonic laser light; a concave mirror having a concave surface opposing the conversion element; and a mirror supporter supporting the concave mirror. The mirror supporter has a mouth that transmits laser light from the conversion element toward the concave mirror, and a contacting surface orthogonally intersecting an optical axis of the laser light from the conversion element and contacting the concave surface side of the concave mirror.

### CROSS-REFERENCE TO RELATED APPLICATIONS

The present application claims priority under 15 U.S.C. §119 of Japanese Application No. 2011-142110, filed on Jun. 27, 2011, the disclosure of which is expressly incorporated by reference herein in its entirety.

### BACKGROUND OF THE INVENTION

1. Field of the Invention

The present invention relates to a laser light source apparatus. The present invention especially relates to a laser light source apparatus employed as a light source of an image display apparatus.

2. Description of Related Art

In recent years, technology employing a semiconductor laser as a light source of an image display apparatus has drawn attention. Compared with a mercury lamp conventionally used for an image display apparatus, the semiconductor laser has various advantages including good color reproducibility, instant light-up, long life, high efficiency reducing power consumption, easy miniaturization, and the like.

The laser light source apparatus used for such an image display apparatus does not have any high-power semiconductor laser that can directly output green color laser light. Therefore, as disclosed in Japanese Laid-open Publication No. 2008-016833, a technology is known in which a semiconductor laser emits excitation laser light, a laser medium is excited by the excitation laser light and outputs infrared laser light, a wavelength conversion element converts a wavelength of the infrared laser light, and thus emits green color laser light.

Further, in the conventional technology, a concave mirror is provided to an optical resonator, the concave mirror having a dielectric reflection film that is highly reflective to a fundamental wave and highly transmissive to a second harmonic wave. Output of laser light changes according to a position and angle of the concave minor with respect to an optical path of the laser light. Thus, in installing the concave mirror, it is desirable to determine the position of the concave mirror such that the center (regular reflection point or specular point) of the concave surface and the optical path of laser light align with each other so as to maximize the output of the laser light output.

In the above-mentioned conventional technology, however, due to a manufacturing error in the concave mirror, simply determining a position of the concave mirror does not necessarily match the center of the concave surface with the optical path of the laser light. Thus, a circumstance arises in which there is not enough margin (range within which an optical axis of laser light can be displaced by changing a position and tilt of each optical element) for adjustment of an optical axis of laser light including other optical elements in the laser light source apparatus, causing difficulty in the adjustment. In particular, when a concave mirror of a small size (an outer diameter is 0.5 mm, for example) is employed, such a difficulty becomes distinctive.

### SUMMARY OF THE INVENTION

The advantage of the present invention is to provide a laser light source apparatus capable of maintaining laser output in a preferable level as well as controlling a margin for optical axis adjustment required for other optical elements.

In order to attain the advantage, a laser light source apparatus of the present invention includes: a semiconductor laser emitting excitation laser light; a laser medium being excited by the excitation laser light and emitting infrared laser light; a wavelength conversion element converting a wavelength of the infrared laser light and emitting harmonic laser light; a concave mirror having a concave surface opposing the wavelength conversion element and configuring a resonator along with the laser medium through the wavelength conversion element; and a concave mirror supporter supporting the concave mirror. The concave minor supporter has a mouth that transmits laser light from the wavelength conversion element toward the concave minor, and a contacting surface that orthogonally intersects with an optical axis of the laser light from the wavelength conversion element and is provided to a surrounding area on one end side of the mouth to be in contact with the concave surface side of the concave mirror.

Another advantage of the present invention is to simply and easily determine a position of the concave mirror using the center of the concave mirror as a reference.

Further another advantage of the present invention is to easily perform an optical axis adjustment of each optical element using the center of the concave mirror as a reference, and to inhibit a margin for the optical axis adjustment required for each optical element.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 schematically illustrates a configuration of an image display apparatus according to the present invention;

FIG. 2 is a schematic view illustrating a state of laser light in a green color laser light source apparatus 2;

FIG. 3 is a partially cutout perspective view illustrating an internal configuration of the green color laser light source apparatus according to the present invention;

FIG. 4 is a cross-section view illustrating an internal configuration of the green color laser light source apparatus according to the present invention;

FIG. 5A is a partial perspective view illustrating an installation structure of a concave mirror with respect to a concave mirror supporter in the green color laser light source apparatus of the present invention;

FIG. 5B is a right side view illustrating an installation structure of the concave mirror with respect to the concave mirror supporter in the green color laser light source apparatus of the present invention;

FIG. 6 is a perspective view of a wavelength conversion element employed in the present invention;

FIG. 7 is an exploded perspective view of a wavelength conversion element holder employed in the present invention;

FIG. 8 is a partially exploded perspective view of the green color laser light source apparatus employed in the present invention;

FIG. 9 is a chart illustrating a change in wavelength conversion efficiency η according to a tile angle θ of the wavelength conversion element with respect to an optical axis direction;

FIG. 10A is a cross-section view illustrating an example of a standard shape of the concave mirror of the present invention;

FIG. 10B is a cross-section view illustrating an example of an actual shape of the concave mirror of the present invention;

FIG. 11 is an explanatory diagram illustrating an installation structure of the concave mirror of the present invention; and

FIG. 12 is an explanatory diagram illustrating a comparative example of the installation structure in FIG. 11.

### DETAILED DESCRIPTION OF PREFERRED EMBODIMENTS

The particulars shown herein are by way of example and for purposes of illustrative discussion of the embodiments of the present invention only and are presented in the cause of providing what is believed to be the most useful and readily understood description of the principles and conceptual aspects of the present invention. In this regard, no attempt is made to show structural details of the present invention in more detail than is necessary for the fundamental understanding of the present invention, the description is taken with the drawings making apparent to those skilled in the art how the forms of the present invention may be embodied in practice.

Hereinafter, an embodiment of the present invention will be explained with reference to the drawings.

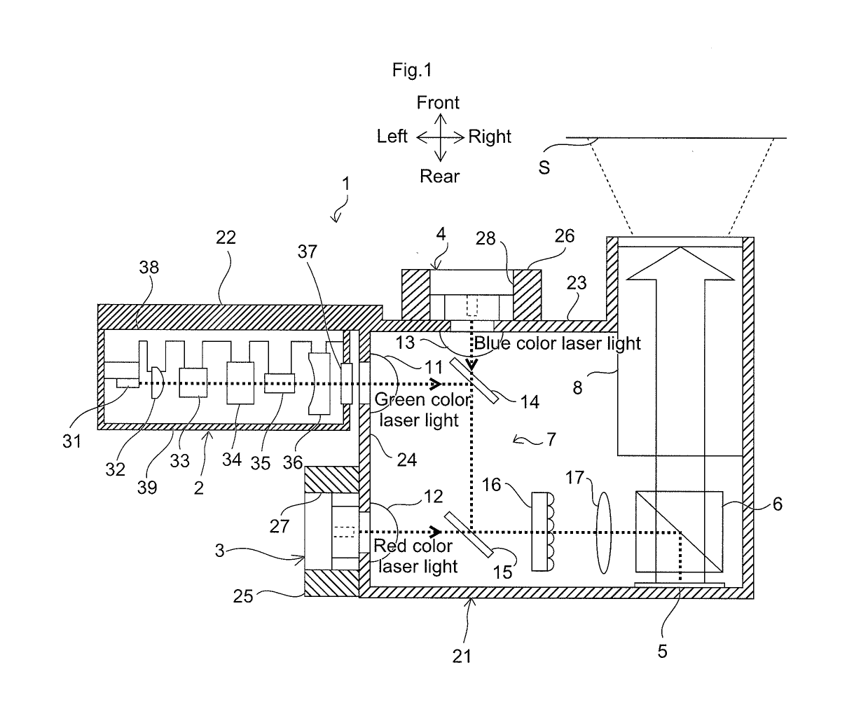

FIG. 1 schematically illustrates a configuration of an image display apparatus 1 according to the present invention. The image display apparatus 1 projects a predetermined image to display on a screen, and is configured with a green color laser light source apparatus 2 emitting green color laser light; a red color laser light source apparatus 3 emitting red color laser light; a blue color laser light source apparatus 4 emitting blue color laser light; a liquid crystal reflective type spatial light modulator 5 modulating the laser light emitted from each of the laser light source apparatuses 2 to 4, according to image signals; a polarization beam splitter 6 reflecting the laser light emitted from each of the laser light source apparatuses 2 to 4, radiating the laser light onto the spatial light modulator 5, and transmitting the modulated laser light emitted from the light modulator 5; a relay optical system 7 guiding the laser light emitted from each of the laser light source apparatuses 2 to 4 to the polarization beam splitter 6; and a projection optical system 8 projecting on the screen the modulated laser light that has been transmitted through the polarization beam splitter 6.

The image display apparatus 1 displays a color image in a field sequential system. Laser light of each color is sequentially emitted from each of the laser light source apparatuses 2 to 4 on a time division basis. Images of the laser light of each color are recognized as a color image due to a residual image effect of eyes.

The relay optical system 7 includes collimator lenses 11 to 13; a first dichroic mirror 14 and a second dichroic mirror 15; a diffuser panel 16; and a field lens 17. The collimator lenses 11 to 13 convert the laser light having respective colors into a parallel beam, the laser light being emitted from the laser light source apparatuses 2 to 4, respectively. The first dichroic minor 14 and the second dichroic mirror 15 guide the laser light having respective colors in a predetermined direction, the laser light having passed through the collimator lenses 11 to 13. The diffuser panel 16 diffuses the laser light guided by the dichroic mirrors 14 and 15. The field lens 17 converts the laser light having passed through the diffuser panel 16 into a converging laser.

When a side on which the laser light is emitted from the projection optical system 8 toward the screen S is a front side, the blue color laser light is emitted rearward from the blue color laser light source apparatus 4. The green color laser light is emitted from the green color laser light source apparatus 2 and the red color laser light is emitted from the red color laser light source apparatus 3, such that an optical axis of the green color laser light and an optical axis of the red color laser light each orthogonally intersect with an optical axis of the blue color laser light. The blue color laser light, the red color laser light, and the green color laser light are guided to the same optical path by the two dichroic mirrors 14 and 15. Specifically, the blue color laser light and the green color laser light are guided to the same optical path by the first dichroic minor 14; and the blue color laser light, the green color laser light, and the red color laser light are guided to the same optical path by the second dichroic mirror 15.

Each of the first dichroic mirror 14 and the second dichroic minor 15 is provided with a film on a surface thereof to transmit and reflect laser light having a predetermined wavelength. The first dichroic mirror 14 transmits the blue color laser light and reflects the green color laser light. The second dichroic minor 15 transmits the red color laser light and reflects the blue color laser light and the green color laser light.

The optical members above are supported by a case 21. The case 21 acts as a heat dissipater dissipating heat generated at the laser light source apparatuses 2 to 4. The case 21 is formed of a highly thermally conductive material, such as aluminum or copper.

The green color laser light source apparatus 2 is mounted to a mounting portion 22, which is provided to the case 21 in a state projecting to a side. The mounting portion 22 is provided projecting orthogonally to a side wall 24 from a corner where a front wall 23 and the side wall 24 intersect, the front wall 23 being positioned in the front of a housing space of the relay optical system 7, and the side wall 24 being positioned on the side of the housing space. The red color laser light source apparatus 3 is mounted on an external surface of the side wall 24 in a state being held by a holder 25. The blue color laser light source apparatus 4 is mounted on an external surface of the front wall 23 in a state being held by a holder 26.

The red color laser light source apparatus 3 and the blue color laser light source apparatus 4 are provided in a CAN package, in which a laser chip emitting laser light is disposed such that an optical axis is positioned on a central axis of a can-shaped external portion in a state where the laser chip is supported by a stem. The laser light is emitted through a glass window provided to an opening of the external portion. The red color laser light source apparatus 3 and the blue color laser light source apparatus 4 are press-fitted into and thusly fixed by attachment holes 27 and 28, respectively, which are provided in the holders 25 and 26, respectively. Heat generated by the laser chips of the red color laser light source apparatus 3 and the blue color laser light source apparatus 4 is transferred through the holders 25 and 26, respectively, to the case 21 and dissipated. The holders 25 and 26 are formed of a highly thermally conductive material, such as aluminum or copper.

The green color laser light source apparatus 2 includes a semiconductor laser 31; an FAC (Fast-Axis Collimator) lens 32; a rod lens 33; a laser medium 34; a wavelength conversion element 35; a concave mirror 36; a glass cover 37; a base 38 supporting the components; and a cover body 39 covering the components. The semiconductor laser 31 emits excitation laser light. The FAC lens 32 and the rod lens 33 are collecting lenses that collect the excitation laser light emitted from the semiconductor laser 31. The laser medium 34 is excited by the excitation laser light and emits fundamental laser light (infrared laser light). The wavelength conversion element 35 converts a wavelength of the fundamental laser light and emits half wavelength laser light (green color laser light). The concave mirror 36, together with the laser medium 34, configures a resonator. The glass cover 37 prevents leakage of the excitation laser light and the fundamental wavelength laser light.

The base 38 of the green color laser light source apparatus 2 is fixed to the mounting portion 22 of the case 21. A space having a predetermined width (0.5 mm or less, for example) is provided between the green color laser light source apparatus 2 and the side wall 24 of the case 21. Thereby, the heat of the green color laser light source apparatus 2 becomes less likely to be transferred to the red color laser light source apparatus 3. An increase in temperature of the red color laser light source apparatus 3 is thereby inhibited. The red color laser light source apparatus 3, which has undesirable temperature properties, can thus be stably operated. Furthermore, in order to secure a predetermined margin for optical axis adjustment (approximately 0.3 mm, for example) of the red color laser light source apparatus 3, a space having a predetermined width (0.3 mm or more, for example) is provided between the green color laser light source apparatus 2 and the red color laser light source apparatus 3.

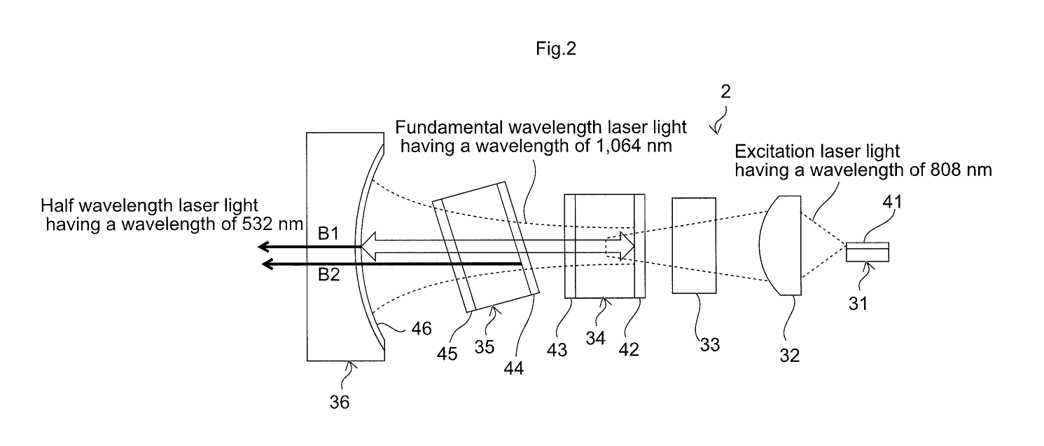

FIG. 2 is a schematic view illustrating a state of laser light in the green color laser light source apparatus 2. A laser chip 41 of the semiconductor laser 31 emits excitation laser light having a wavelength of 808 nm. The FAC lens 32 reduces expansion of a fast axis (direction orthogonal to an optical axis direction and along a paper surface of the drawing) of the laser light. The rod lens 33 reduces expansion of a slow axis (direction orthogonal to a paper surface of the drawing) of the laser light.

The laser medium 34, which is a solid-state laser crystal, is excited by the excitation laser light having a wavelength of 808 nm and having passed through the rod lens 33, and emits fundamental wavelength laser light (infrared laser light) having a wavelength of 1,064 nm. The laser medium 34 is an inorganic optically active substance (crystal) formed of Y (yttrium) and VO₄ (vanadate) doped with Nd (neodymium). More specifically, the Y of the base material YVO₄ is substituted and doped with Nd⁺³, which is an element producing fluorescence.

A film 42 is provided to the laser medium 34 on a side opposite to the rod lens 33, the film 42 preventing reflection of the excitation laser light having a wavelength of 808 nm and highly reflecting the fundamental wavelength laser light having a wavelength of 1,064 nm and the half wavelength laser light having a wavelength of 532 nm. A film 43 is provided to the laser medium 34 on a side opposite to the wavelength conversion element 35, the film 43 preventing reflection of the fundamental wavelength laser light having a wavelength of 1,064 nm and the half wavelength laser light having a wavelength of 532 nm.

The wavelength conversion element 35, which is an SHG (Second Harmonics Generation) element, converts a wavelength of the fundamental wavelength laser light (infrared laser light) having a wavelength of 1,064 nm emitted from the laser medium 34, and generates the half wavelength laser light (green color laser light) having a wavelength of 532 nm.

A film 44 is provided to the wavelength conversion element 35 on a side opposite to the laser medium 34, the film 44 preventing reflection of the fundamental wavelength laser light having a wavelength of 1,064 nm and highly reflecting the half wavelength laser light having a wavelength of 532 nm. A film 45 is provided to the wavelength conversion element 35 on a side opposite to the concave mirror 36, the film 45 preventing reflection of the fundamental wavelength laser light having a wavelength of 1,064 nm and the half wavelength laser light having a wavelength of 532 nm.

The concave mirror 36 has a concave surface on a side opposite to the wavelength conversion element 35. The concave surface is provided with a film 46 highly reflecting the fundamental wavelength laser light having a wavelength of 1,064 nm and preventing reflection of the half wavelength laser light having a wavelength of 532 nm. Thereby, the fundamental wavelength laser light having a wavelength of 1,064 nm is resonated and amplified between the film 42 of the laser medium 34 and the film 46 of the concave mirror 36.

The wavelength conversion element 35 converts a portion of the fundamental wavelength laser light having a wavelength of 1,064 nm that has entered from the laser element 34 to the half wavelength laser light having a wavelength of 532 nm. A portion of the fundamental wavelength laser light having a wavelength of 1,064 nm that is not converted and has passed through the wavelength conversion element 35 is reflected by the concave mirror 36. The reflected fundamental wavelength laser light then re-enters the wavelength conversion element 35, and is partially converted to the half wavelength laser light having a wavelength of 532 nm. The half wavelength laser light having a wavelength of 532 nm is reflected by the film 44 of the wavelength conversion element 35 and emitted from the wavelength conversion element 35. The laser light having a wavelength of 1,064 nm that is not converted and is transmitted after re-entering the wavelength conversion element 35 is reflected by the film 42 of the laser medium 34. The reflected fundamental wavelength laser light then re-enters the wavelength conversion element 35, is partially converted to the half wavelength laser light having a wavelength of 532 nm, and is emitted from the wavelength conversion element 35.

A laser light beam B1 enters the wavelength conversion element 35 from the laser medium 34, is converted to a different wavelength at the wavelength conversion element 35, and is emitted from the wavelength conversion element 35. A laser light beam B2 is once reflected by the concave mirror 36, enters the wavelength conversion element 35, is reflected by the film 44, and is emitted from the wavelength conversion element 35. In a state where the laser light beam B1 and the laser light beam B2 overlap to each other, the half wavelength laser light having a wavelength of 532 nm and the fundamental wavelength laser light having a wavelength of 1,064 nm interfere, thereby reducing the output.

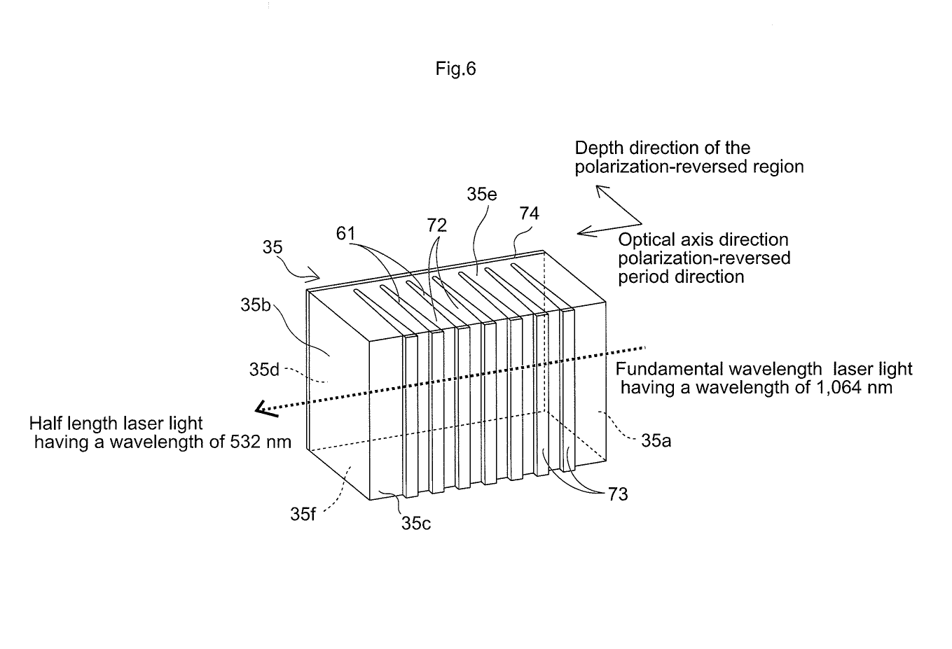

The wavelength conversion element 35 is thus tilted relative to the optical axis direction to prevent the laser light beams B1 and B2 from overlapping to each other by refraction at the incident surface 35a and the emission surface 35b (see FIG. 6). Thus, interference between the half wavelength laser light having a wavelength of 532 nm and the fundamental wavelength laser light having a wavelength of 1,064 nm is prevented, thereby reduction in output can be prevented.

Further, in order to prevent an external leakage of the excitation laser light having a wavelength of 808 nm and the fundamental wavelength laser light having a wavelength of 1,064 nm, a film not transmissive to these laser lights is provided on the glass cover 37 shown in FIG. 1.

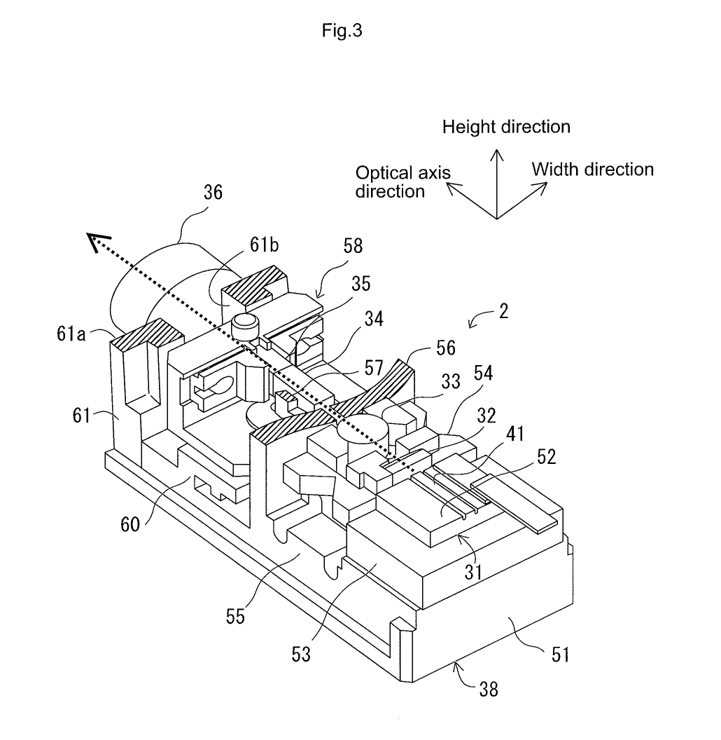

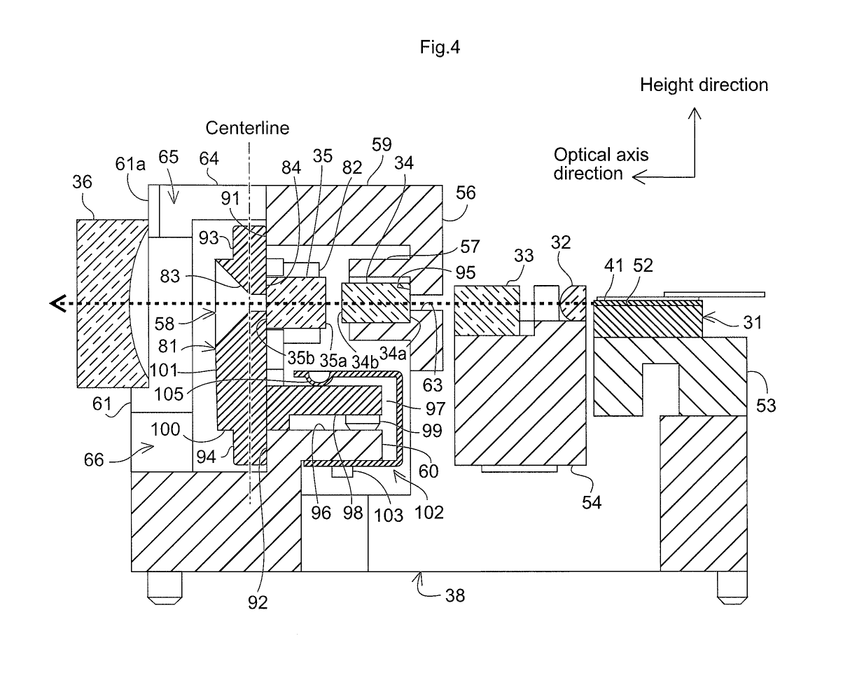

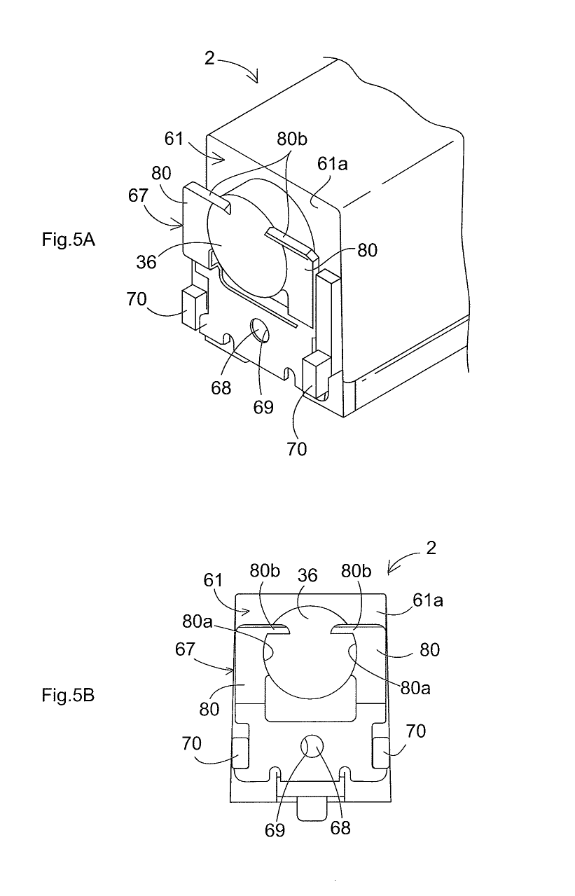

FIG. 3 is a partially cutout perspective view illustrating an internal configuration of the green color laser light source apparatus 2. FIG. 4 is a cross-section view illustrating an internal configuration of the green color laser light source apparatus 2. FIG. 5A is a partial perspective view illustrating an installation structure of the concave mirror 36 with respect to a concave mirror supporter 61. FIG. 5B is a right side view illustrating an installation structure of the concave mirror 36 with respect to the concave mirror supporter 61. In FIGS. 5A and 5B, illustration on a part of the configuration, such as the glass cover 37 and the like, is omitted.

As shown in FIG. 3, the semiconductor laser 31, the FAC lens 32, the rod lens 33, the laser medium 34, the wavelength conversion element 35, and the concave mirror 36 are integrally supported by the base 38. A bottom surface 51 of the base 38 is parallel to an optical axis direction. In this embodiment, a direction orthogonally intersecting with the bottom surface 51 of the base 38 is refereed to as a height direction, and a direction orthogonally intersecting with both of the height direction and the optical axis direction is referred to as a width direction. In addition, descriptions are made referring a side close to the bottom surface 51 of the base 38 as bottom, and a side opposite to the bottom surface 51 as top. However, these do not necessarily match the vertical direction of an actual device.

The semiconductor laser 31 is a laser chip 41 mounted on a mounting member 52, the laser chip 41 emitting laser light. The laser chip 41 has a long plate-like shape extending in the optical axis direction. The laser chip 41 is fixed in the substantial center in the width direction on one surface of the plate-like-shaped mounting member 52 in a state where a light emission surface of the laser chip 41 is directed toward the FAC lens 32. The semiconductor laser 31 is fixed to the base 38 via a fixing member 53. The fixing member 53 is formed of a highly thermally conductive metal, such as copper, aluminum, and the like. Thus, heat generated from the laser chip 41 can be transferred to and dissipated from the base 38.

The FAC lens 32 and the rod lens 33 are held by a collecting lens holder 54. The collecting lens holder 54 is supported by a supporter 55 that is integrally formed on the base 38. The collecting lens holder 54 is connected to the supporter 55 movably in the optical axis direction. Thereby, a position of the collecting lens holder 54, specifically, the FAC lens 32 and the rod lens 33, is adjusted in the optical axis direction. The FAC lens 32 and the rod lens 33 are fixed to the collecting lens holder 54 with an adhesive prior to the position adjustment. The collecting lens holder 54 and the supporter 55 are fixed to each other with an adhesive after the position adjustment.

The laser medium 34 is supported by a laser medium supporter 56 that is integrally formed on the base 38. As shown in FIG. 4, the laser medium supporter 56 erects on the base 38 so as to form a partition wall. The laser medium supporter 56 is provided with a laser medium holder 57 holding the laser medium 34 and projecting to the side. The laser medium supporter 56 has an optical path opening 63 guiding laser light emitted from the rod lens 33 to the laser medium 34. The laser medium 34 and the laser medium holder 57 are fixed to each other with an adhesive.

Referring again to FIG. 3, the wavelength conversion element 35 is held by a wavelength conversion element holder 58. The wavelength conversion element holder 58 is provided movably in the width direction with respect to the base 38 and rotatably around an axis substantially orthogonal with respect to the optical axis direction. The wavelength conversion element holder 58 thus can adjust a position of the wavelength conversion element 35 in the width direction and a tilt angle of the wavelength conversion element 35 with respect to the optical axis direction. The wavelength conversion element holder 58 will be described in detail later. The wavelength conversion element 35 is fixed to the wavelength conversion element holder 58 with an adhesive prior to the position adjustment. The wavelength conversion element holder 58 and the base 38 are fixed to each other with an adhesive after the position adjustment.

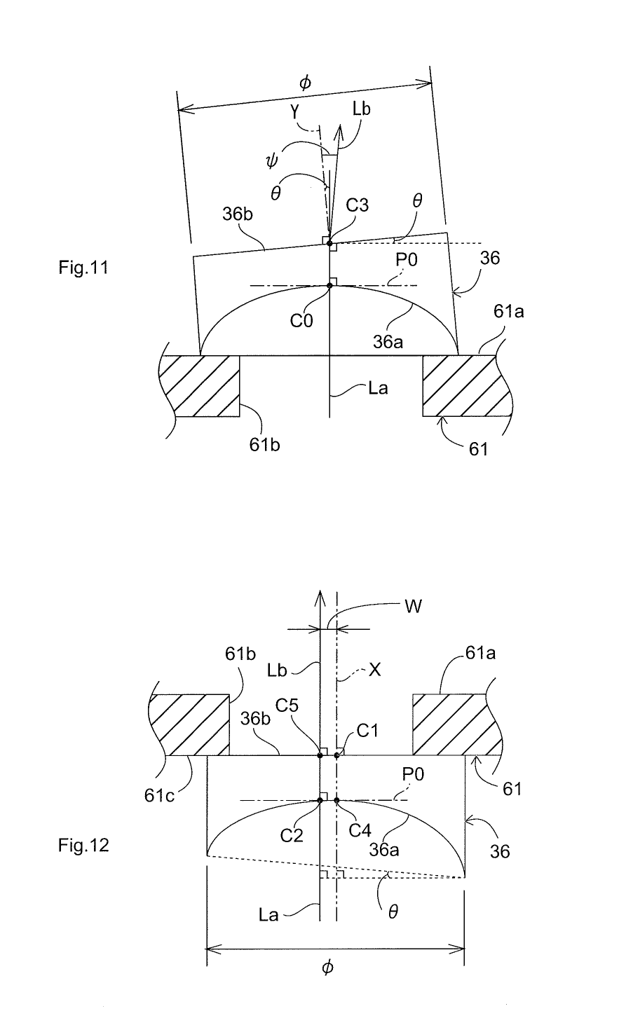

The concave mirror 36 is supported by the concave mirror supporter 61 that is integrally formed on the base 38. More specifically, as shown in FIG. 5A, the concave mirror 36 is held by a flat spring (elastic pressing member) 67 in a state in which a peripheral edge of a concave surface 36a side thereof is in contact with an outer surface (contacting surface) 61a of the concave mirror supporter 61 (see FIG. 11).

As shown in FIG. 5B, a positioning hole 69 is provided to a lower portion of the flat spring 67. A positioning pin 68 is provided to the concave mirror supporter 61 and is fitted into the hole 69. Both sides in the width direction at the lower portion of the flat spring 67 where the hole 69 is provided are fixed by a pair of projections 70 having an aduncate shape and being provided to the concave mirror supporter 61. A pair of supporting arms 80 is provided to an upper portion of the flat spring 67 while having a space between each other in the width direction, the supporting arms 80 being elastically deformable and substantially L-shaped. Each supporting arm 80 is provided with an arc shaped contacting edge 80a formed on a side opposing to the other supporting arm 80. The two supporting arms 80 sandwich, through the contacting edges 80a, a portion of a peripheral surface of the concave mirror 36, the surface being located in a middle in a height direction. Each of the supporting arms 80 is provided at a tip thereof having a pressing piece 80b, so that the two supporting arms 80 press the concave mirror 36 toward the concave mirror supporter 61 side. The concave mirror 36 is movable to such an extent that positioning (described later) thereof can be performed in a state being held by the flat spring 67. Such a configuration allows the concave mirror to be held in an initial position as well as to be easily moved (positioned) thereafter, as described later.

Further, as shown in FIG. 3, the concave mirror supporter 61 is provided with a mouth 61b that transmits laser light from the wavelength conversion element 35 toward the concave mirror 36. The concave surface 36a of the concave mirror 36 opposes the wavelength conversion element 35 through the mouth 61b. The outer surface 61a is in contact with the concave mirror 36 and essentially orthogonally intersects with the optical axis of the laser light from the wavelength conversion element 35. Further, the outer surface 61a is provided to a surrounding area outside (the glass cover 37 side of) the mouth 61b. The mouth 61b may have various shapes such as a hole, a notch, or the like.

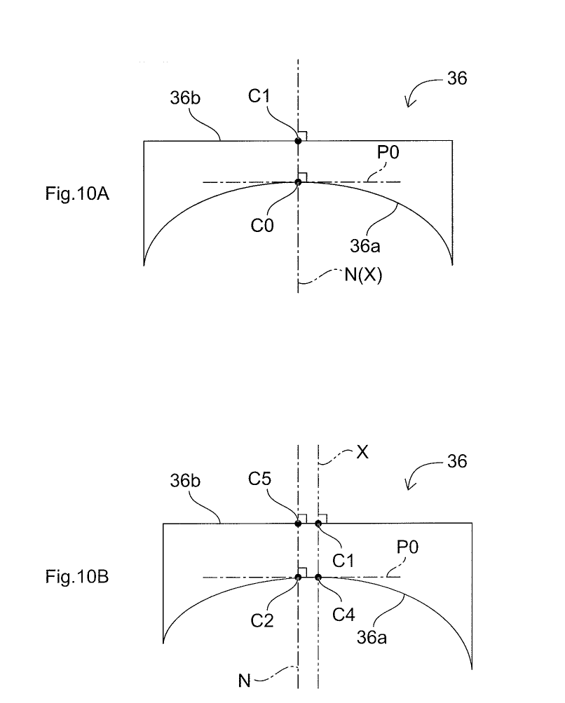

Although a detailed description is provided later, the initial position of the concave mirror 36 held by the flat spring 67 (that is, a standard position of each optical element in the green color laser light source apparatus 2 at the time of optical axis adjustment) is set such that an optical path (standard optical path) of laser light from the wavelength conversion element 35 passes through a center (that is, a center point C1 of a flat surface 36b shown in FIGS. 10A and 10B) of the concave mirror 36. As a result, a proper position (position where a laser output is maximized) of the concave mirror 36 is determined by a position adjustment at the outer surface 61a, and thereafter the concave mirror 36 is fixed to the concave mirror supporter 61 with an adhesive (not shown in the drawings) at the proper position.

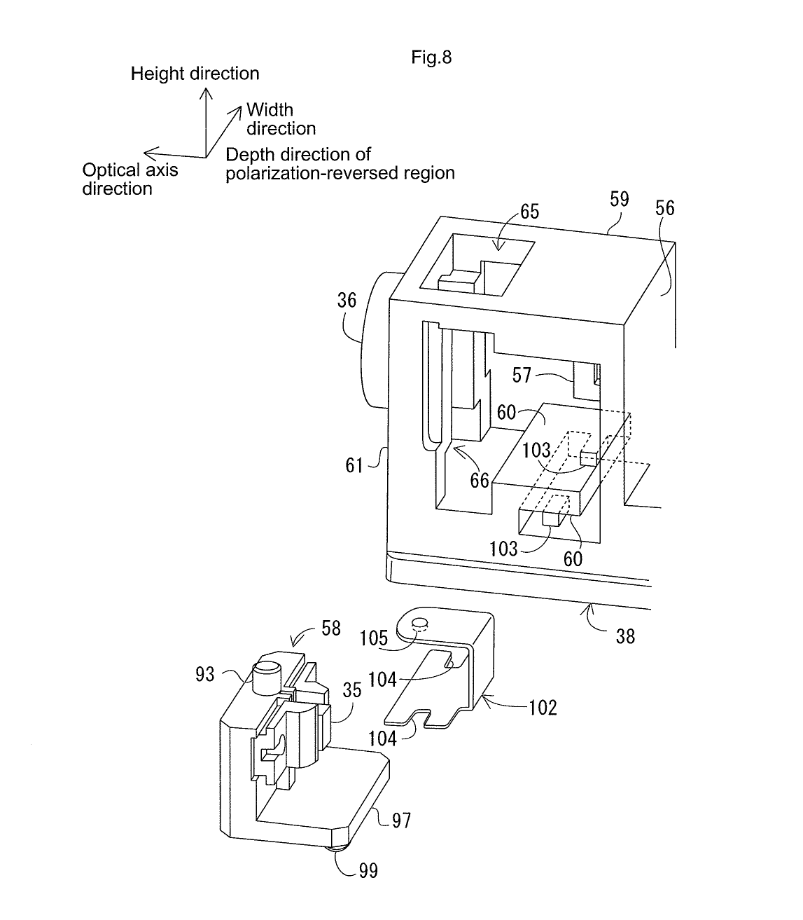

As shown in FIG. 4, the base 38 is provided with a bridge 64 such that a top end of the concave mirror supporter 61 and a top end of the laser medium supporter 56 are mutually connected by the bridge 64. The bridge 64 is provided with an opening 65 to which an adjustment jig (described in detail later) is inserted. Further, the concave mirror 36 is provided at its lower side with an opening 66 to which an adjustment jig is inserted (see also FIG. 8 for configurations of the openings 65 and 66).

As an adhesive employed to fix each of the above-described components, such as the wavelength conversion element holder 58 and the base 38, for example, a UV-curable adhesive is suitable, for example.

FIG. 6 is a perspective view of the wavelength conversion element 35. The wavelength conversion element 35 has a periodically polarization-reversed structure, in which a polarization-reversed region 71 and a polarization non-reversed region 72 are alternately formed on a ferroelectric crystal. Fundamental wavelength laser light enters the wavelength conversion element 35 in a direction of the polarization-reversed period (arrangement direction of the polarization-reversed region 71). With this, second harmonic wave of the incident light is generated by a quasi-phase matching, and thus frequency of a double length, that is, half-wavelength laser light (harmonic laser light) can be obtained.

A periodic electrode 73 and a counter electrode 74 are used to apply an electric field to single-polarized ferroelectric crystal in a direction opposite to a polarization direction. Then, a polarization direction in a portion corresponding to the periodic electrode 73 is reversed, and the polarization-reversed region 71 is formed in a wedge shape from the periodic electrode 73 toward the counter electrode 74.

In reality, a periodically polarization-reversed structure is formed on a base board of a ferroelectric crystal, and then the board is cut to have a predetermined dimension to obtain a piece of the wavelength conversion element 35. An incident surface 35a and an emission surface 35b are formed by precise optical polishing on a plane that is parallel to a depth direction of the polarization-reversed region 71. Further, ultimately, the periodic electrode 73 and the counter electrode 74 on side surfaces 35c and 35d are eliminated by polishing. As a ferroelectric crystal, MgO doped LN (lithium niobate) is used, for example.

The polarization-reversed region 71 has a wedge shape with a width gradually decreasing following a depth direction. The wavelength conversion element 35 is moved in the depth direction of the polarization-reversed region 71 with respect to incident laser light. Thereby, a change occurs in a ratio of the polarization-reversed region 71 and the polarization non-reversed region 72 situated on an optical path of the laser light. Accordingly, there is a change in wavelength conversion efficiency. Therefore, a position of the wavelength conversion element 35 with respect to the optical axis of the laser light is adjusted such that the wavelength conversion efficiency becomes highest, that is, the output of the laser light becomes greatest. The position adjustment of the wavelength conversion element 35 will be described in detail later.

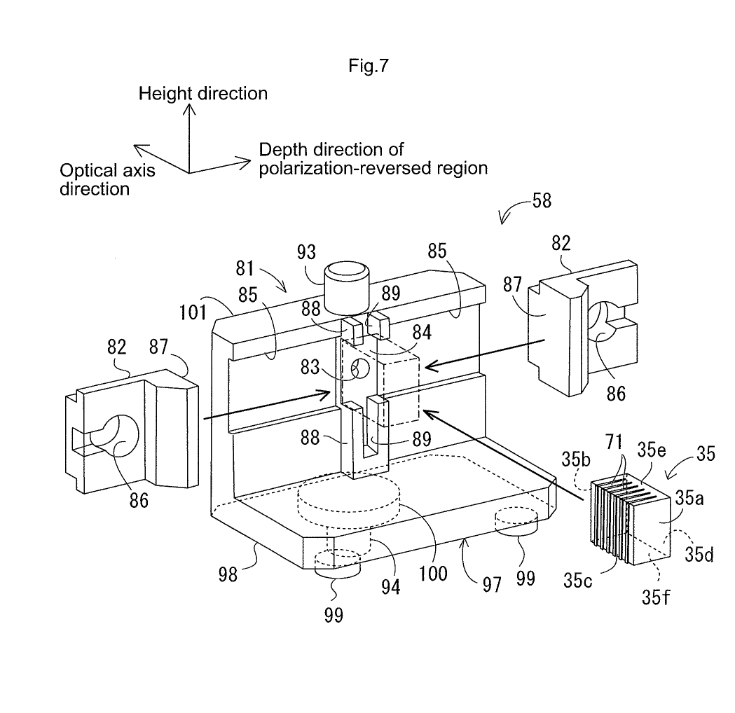

FIG. 7 is an exploded perspective view of the wavelength conversion element holder 58. FIG. 8 is a partially-exploded perspective view of the green color laser light source apparatus 2.

As shown in FIG. 7, the wavelength conversion element holder 58 is configured with a holder main body 81 and a pair of sandwiching members 82, the holder main body 81 and the sandwiching members 82 being separately formed. The holder main body 81 is provided with an optical path opening 83 that guides laser light emitted from the wavelength conversion element 35 to the concave mirror 36. The emission side of the optical path opening 83 expands in a funnel shape (also see FIG. 4).

Parallelism between the incident surface 35a and the emission surface 35b of the wavelength conversion element 35 is highly accurately secured by precise polishing. However, squareness of the side surfaces 35c and 35d, a top surface 35e, and a bottom surface 35f of the wavelength conversion element 35, with respect to the incident surface 35a and the emission surface 35b are not secured. Further, parallelism between mutually opposing components among the side surfaces 35c and 35d, the top surface 35e, and the bottom surface 35f of the wavelength conversion element 35 is not secured. Thus, a manufacturing error is generated when the base board is cut. Therefore, the emission surface 35b, whose accuracy is secured, is abutted to an installation reference surface 84 where the optical path opening 83 opens, in order to perform positioning of the wavelength conversion element 35.

The pair of the sandwiching members 82 is each in contact with each of the two side surfaces 35c and 35d, respectively, which opposes to each other in a depth direction of the polarization-reversed region 71 in the wavelength conversion element 35. The pair of the sandwiching members 82 is thus installed so as to sandwich the wavelength conversion element 35 from left and right. The holder main body 81 is provided with a guiding groove 85 to which the sandwiching members 82 are fitted. The guiding groove 85 regulates the position of the sandwiching members 82 in a height direction. The holder main body 81 and the sandwiching members 82 are fixed with an adhesive. The sandwiching members 82 are provided with a hole 86 to which the adhesive is applied.

Contacting surfaces 87 of the sandwiching members 82 are in contact with the side surfaces 35c and 35d of the wavelength conversion element 35, and the contacting surface 87 is applied with a conductive adhesive. The holder main body 81 and the sandwiching members 82 are made from a conductive material such as metal materials and the like. Thereby, the side surfaces 35c and 35d of the wavelength conversion element 35 are electrically connected to each other, and accordingly the side surfaces 35c and 35d are maintained at the same electrical potential. It is thus possible to inhibit a change in refraction index caused by charging-up.

The holder main body 81 is provided with a holder 88 that sandwiches the wavelength conversion element 35 from top and bottom. The holder 88 is provided with a groove 89 to which an adhesive is applied. Thus, the adhesive is attached to the top surface 35e and the bottom surface 35f of the wavelength conversion element 35, and through the adhesive, the wavelength conversion element 35 and the holder main body 81 are fixed to each other.

As shown in FIG. 4, the base 38 is provided with first reference surfaces 91 and 92, the first reference surfaces 91 and 92 forming planes orthogonally intersecting with the optical axis direction. The first reference surfaces 91 and 92 are each provided to an upper holder supporter 59 and a lower holder supporter 60 at the concave mirror 36 side thereof, the upper holder supporter 59 and the lower holder supporter 60 being integrally formed with the base 38. The upper holder supporter 59 is provided to the bridge 64 that connects the laser medium supporter 56 and the concave mirror supporter 61 to each other.

Further, the wavelength conversion element holder 58 is provided with a pair of axes 93 and 94 that are in contact with the first reference surfaces 91 and 92. The pair of axes 93 and 94 is in a cylindrical shape having the same diameter, is mutually coaxially arranged, and is provided to the holder main body 81 in a state projecting in directions opposite to each other (also see FIG. 7). The first reference surfaces 91 and 92 are arranged on the same plane that orthogonally intersects with the optical axis direction. The axes 93 and 94 are regulated by the first reference surfaces 91 and 92, thereby the position of the wavelength conversion element holder 58 in the optical axis direction is determined.

The axes 93 and 94 can slide, in the width direction, along the first reference surfaces 91 and 92. Accordingly, the wavelength conversion element holder 58 can move in the width direction (the depth direction of the polarization-reversed region) with respect to the base 38 without changing the position of the wavelength conversion element holder 58 in the optical axis direction. In addition, the axes 93 and 94 can rotate in a contact state with the first reference surfaces 91 and 92. Accordingly, the wavelength conversion element holder 58 can rotate around an axis that more or less orthogonally intersects with the optical axis direction.

The positioning of the wavelength conversion element 35 is performed with the installation reference surface 84 of the wavelength conversion element holder 58, the installation reference surface 84 having the optical path opening 83. The installation reference surface 84 is arranged in parallel to generatrices of the pair of axes 93 and 94, the generatrices forming cylindrical surfaces. The positioning of the laser medium 34 is performed by abutting the incident surface 34a against an installation reference surface 95 having the optical path opening 63. Accordingly, by controlling the parallelism between the installation reference surface 84 of the wavelength conversion element 35 and the centerlines of the axes 93 and 94 in the wavelength conversion element holder 58, and by controlling the parallelism between the installation reference surface 95 of the laser medium 34 and the first reference surfaces 91 and 92 in the base 38, it is possible to ensure the parallelism between the incident surface 35a and the emission surface 35b of the wavelength conversion element 35, and the incident surface 34a and the emission surface 34b of the laser medium 34.

The lower holder supporter 60 is provided with a second reference surface 96 that is a plane orthogonally intersecting with the first reference surfaces 91 and 92. The second reference surface 96 is arranged in parallel to the optical axis direction and the depth direction of the polarization-reversed region 71 of the wavelength conversion element 35.

Further, the wavelength conversion element holder 58 is provided with a foot 97 that is in contact with the second reference surface 96. The foot 97 is configured with a plate-like portion 98, two bosses 99 formed on a lower surface of the plate-like portion 98, and a step 100 (see FIG. 7). The plate-like portion 98 extends out from a base 101 such that the plate-like portion 98 has a L-shaped cross section, the base 101 being provided with the installation reference surface 84 of the wavelength conversion element 35. The plate-like portion 98 is arranged on lower sides of the wavelength conversion element 35 and the laser medium 34. Therefore, spaces on the lower sides of the wavelength conversion element 35 and the laser medium 34 are effectively utilized, and it is thus possible to reduce the size of the apparatus. The axis 94 on the lower side is provided protruding from the step 100.

The two bosses 99 are separately provided in the depth direction of the polarization-reversed region. The step 100 is positioned, relative to the two bosses 99, in the middle of the depth direction of the polarization-reversed region and also at a position shifted in the optical axis direction. End surfaces of the two bosses 99 and the step 100 are configured to have the same height. Thus, it is possible to prevent the pair of axes 93 and 94 of the wavelength conversion element holder 58 from tilting away from the height direction, that is, a regular direction that orthogonally intersects with the optical axis direction and the depth direction of the polarization-reversed region.

Further, the green color laser light source apparatus 2 is provided with a spring 102 that holds the foot 97 of the wavelength conversion element holder 58 such that the foot 97 is in contact with the second reference surface 96. The spring 102 is configured with a flat spring having a cross section in a squared-U-shape. The spring 102 is mounted in a state sandwiching the foot 97 of the wavelength conversion element holder 58 and the lower holder supporter 60 having the second reference surface 96. Thereby, the wavelength conversion element holder 58 can move in a width direction without tilting, and thus position angle adjustment can be easily performed. Bias force of the spring 102 is used for temporary fixation at the time of the position angle adjustment. After the position angle adjustment, the wavelength conversion element holder 58 and the holder supporter 60 are fixed with an adhesive.

As shown in FIG. 8, the spring 102 is provided with a notch 104 to a portion that is in contact with the lower surface side of the holder supporter 60, the notch 104 fitting with a projection 103 provided to the lower surface of the holder supporter 60. Thereby, the movement of the spring 102 in the optical axis direction and the width direction relative to the holder supporter 60 is restricted. The spring 102 is provided with a spherically shaped contact 105 to a portion that is in contact with the upper surface side of the foot 97 of the wavelength conversion element holder 58. Thereby, the foot 97 of the wavelength conversion element holder 58 can smoothly slide with respect to the spring 102, which is fixed to the holder supporter 60.

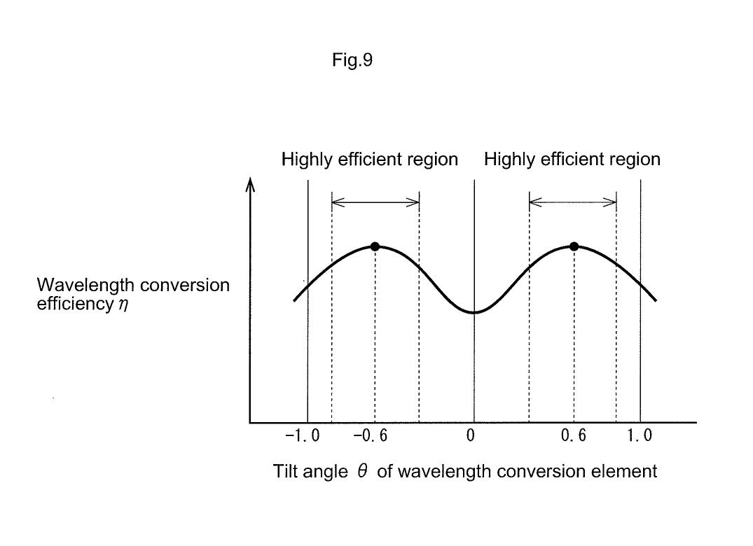

FIG. 9 is a chart illustrating a change in wavelength conversion efficiency η according to a tile angle θ of the wavelength conversion element 35 with respect to the optical axis direction. The wavelength conversion efficiency η of the wavelength conversion element 35 changes according to a tile angle θ of the wavelength conversion element 35 with respect to the optical axis direction. In a state where the wavelength conversion element 35 does not tilt (θ=0) with respect to the optical axis, the wavelength conversion efficiency η is low. The wavelength conversion efficiency η can be increased by tilting the wavelength conversion element 35 with respect to the optical axis direction.

This is because, in a case where the tile angle θ is 0, as shown in FIG. 2, the laser light beams B1 and B2 are overlapped to each other, and thus half length laser light having a wavelength of 532 nm and fundamental wavelength laser light having a wavelength of 1,064 nm interfere with each other. By tilting the wavelength conversion element 35 with respect to the optical axis direction, the laser light beams B1 and B2 do not overlap because of refraction effect at the incident surface 35a and the emission surface 35b. It is thus possible to inhibit reduction in output caused by the interference.

In this embodiment in particular, a tilt angle θ of the wavelength conversion element 35 is adjusted so as to stay within a highly efficient region having a predetermined range (±0.4°, for example) centering around a peak point (θ=0.6°, in this example) of the wavelength conversion efficiency. Dimensions of components are set so that the wavelength conversion element holder 58 can be tilted with respect to the base 38 within an angle range corresponding to the margin for the adjustment.

FIGS. 10A and 10B are cross-section views each schematically illustrating an example of a shape of the concave mirror 36. FIG. 10A illustrates a standard shape (with no manufacturing error), and FIG. 10B illustrates an actual shape (with a manufacturing error). For convenience of description, the shape of the concave mirror 36 is not accurately shown in the drawings here. Thus, it is different from a most suitable shape for a practical use (the same applies to FIGS. 11 and 12 described later).

As shown in FIG. 10A, in the concave mirror 36 having the standard shape (ideal shape), a surface of one side (side opposing to the wavelength conversion element 35) of a tubular material (optical grass having a refraction index of 1.5, in this example) is formed into the concave surface 36a. The concave surface 36a is shown here as an elliptical surface, but it is not limited to this. A spherical surface, a hyperboloidal surface, or the like may be used as needed. A normal line N at a center point C0 of the concave surface 36a aligns with a central axis X of the concave mirror 36 orthogonally intersecting with the flat surface 36b at a center point C1 of the flat surface 36b of the other side. The center point C0 of the concave surface 36a is a regular reflection point at which a tangent plane P0 of the center point C0 is parallel to the flat surface 36b. When the optical axis of the laser light form the wavelength conversion element 35 is aligned with the normal line N, the laser output of the green color laser light source apparatus 2 becomes greatest.

On the other hand, the actual shape of the concave mirror 36 has a manufacturing error (positional misalignment between the concave surface 36a and the flat surface 36b due to a processing error in the concave surface 36a, in this example) as shown in FIG. 10B. In this case, the normal line N on the flat surface 36b passes through a regular reflection point C2 of the concave surface 36a when laser light enters from the concave surface 36a side of the concave mirror 36 in a direction orthogonally intersecting with the flat surface 36b. At this time, the normal line N does not align with the central axis X of the concave mirror 36. In such a state, in a case where an initial position of the concave mirror 36 is determined such that the optical path (that is, a standard optical path at the time of optical axis adjustment) of the laser light aligns with the central axis X, the concave mirror 36 needs to be displaced such that the optical path of the laser light aligns with the normal line N in order to maintain a sufficient level of the laser output of the green color laser light source apparatus 2.

FIG. 11 is an explanatory diagram illustrating an installation structure of the concave mirror 36 of the present invention. FIG. 12 is an explanatory diagram illustrating a comparative example of the installation structure in FIG. 11. For convenience of description, the above-described flat spring 62 and the like are omitted in the drawings here. In addition, ideally, the optical path of the laser light from the wavelength conversion element 35 is designed to pass through the center of the mouth 61b of the concave mirror supporter 61, however that is not the case in reality. The optical path of the laser light from the wavelength conversion element 35 deviates from the center of the mouth 61b due to installation errors in the semiconductor laser 31, the FAC lens 32, the rod lens 33, and the laser medium 34, all of which are arranged anterior to the wavelength conversion element 35 (see FIGS. 1 to 4). FIG. 11 illustrates a case where the optical path of the laser light from the wavelength conversion element 35 passes through the center of the mouth 61b of the concave mirror supporter 61 with no installation error in each of the optical components arranged anterior to the concave mirror 36.

In the present embodiment shown in FIG. 11, the flat surface 36b of the concave mirror 36 is tilted at an angle θ with respect to the outer surface (contacting surface) 61a of the concave mirror supporter 61, and the center point C0 of the concave surface 36a is a regular reflection point. Therefore, as long as the center point C0 of the concave surface 36a aligns with an optical axis La, the laser light output becomes greatest. Ideally, when the concave mirror 36 can be installed in a state such that the optical path of the laser light from the wavelength conversion element 35 passes through the center of the mouth 61b of the concave mirror supporter 61 and the center point C0 of the concave surface 36a of the concave mirror 36 aligns with the center of the mouth 61b, as shown in FIG. 11, it is not necessary to adjust the concave mirror 36. As described above, however, the optical path of the laser light from the wavelength conversion element 35 deviates from the center of the mouth 61b, and the concave mirror 36 cannot be accurately mounted from the beginning such that the center point C0 of the concave mirror 36 aligns with the center of the mouth 61b. Thus, in reality, the concave mirror 36 is slid in a predetermined direction (the height direction and the width direction in FIG. 3) so that the center point C0 of the concave surface 36a aligns with the optical axis La. Thereby, a proper position is determined, in which the laser light output becomes greatest.

At this time, the flat surface 36b is tilted at an angle θ with respect to the outer surface (flat surface) 61a of the concave mirror supporter 61, however, the center point C0 of the concave surface 36a is positioned in a vicinity of the center of the concave mirror 36 having an outer diameter ø (ø=0.5 mm, in this example). Thus, an incident optical path La of laser light is incident from substantially the center point C0 of the concave surface 36a (the optical path La), is slightly refracted by the flat surface 36b, and is emitted toward the glass cover 37 (see FIG. 1) side (an optical path Lb).

Herein, the optical path La of the laser light entering into the concave surface 36a is tilted at a predetermined angle (in this example, a maximum value of the angle θ is 0.2° (maximum amount predicted from processing accuracy)) with respect to a normal line Y on the flat surface 36b passing through an emission point C3 of the optical path Lb. In this state, a tilt angle of the emitted laser light optical path Lb with respect to the normal line Y is 0.3°. The tilt angle ψ of the laser light optical path Lb with respect to the laser light optical path La ψ-θ is merely 0.1° at greatest. Such a slight tilt of the laser light optical path Lb can be resolved by adjusting optical axes of other optical elements arranged in the relay optical system 7 (see FIG. 1) of the image display apparatus 1. Thus, the tilt does not affect the optical axis of the laser light after this point.

In this way, in the concave mirror 36 of the green color laser light source apparatus 2 in its initial position, incident position of the laser light optical path La substantially aligns with the center point C0 of the concave surface 36a. The discrepancy between the optical path Lb after emission and the optical path La on the incident side is very small. In other words, even when an adjustment margin for the concave mirror 36 of the green color laser light source apparatus 2 is not so large, it is possible to obtain required output of the green color laser light, and to easily perform optical axis adjustment in the green color laser light source apparatus 2. In addition, increased freedom in designing optical axis adjustment makes a compact configuration possible. In particular, for a laser light axis in an ideal state shown in FIG. 11, the concave mirror 36 may be adjusted so as to be arranged in its initial position.

Further, as described above, laser light entering into the concave mirror 36 here is shown such that it passes through the center of the mouth 61b of the concave mirror supporter 61. However, the optical path of the entering laser light is not limited to this. Even when it is so, the margin for adjustment of the concave mirror 36 may be simply an estimated displacement of the optical axis of the laser light La due to an installation error in each optical component arranged anterior to the concave mirror 36. It is not necessary to estimate the manufacturing error of the concave mirror 36 itself.

On the other hand, in the comparative example shown in FIG. 12, the concave mirror 36 is held in a state where a peripheral edge of the flat surface 36b side is in contact with an inner surface 61c of the concave mirror supporter 61 (Similar to FIG. 11, FIG. 12 illustrates the case where the optical path of the laser light form the wavelength conversion element 35 passes through the center of the mouth 61b of the concave mirror supporter 61 with no installation error in each optical component arranged anterior to the wavelength conversion element 35). In this case, in the concave mirror 36 in its initial position, a standard optical path of the laser light from the wavelength conversion element 35 is set to pass through the center point C1 of the flat surface 36b (so as to align with the central axis X of the concave mirror 36). However, this installation state is fundamentally the same as that in FIG. 10B. An intersection point C4 between the central axis X passing through the center point C1 and the concave surface 36a is positioned at the center of the concave surface 36a. Due to a manufacturing error, however, the intersection point C4 is not a regular reflection point with respect to the laser light optical path La. Therefore, at the time of optical axis adjustment of each optical element in the green color laser light source apparatus 2, the concave mirror 36 needs to be moved such that the laser light optical path La passes through the regular reflection point C2 of the concave surface 36a. In other words, a margin for adjustment of the concave mirror 36 is not only an estimated displacement of the optical axis of the laser light La due to an installation error in each optical member arranged anterior to the wavelength conversion element 35. A manufacturing error in the concave mirror 36 itself needs to be estimated as well.

In the concave mirror 36 after moving (after positioning), as shown in FIG. 12, the laser light from the wavelength conversion element 35 enters from the center point C2 of the concave surface 36a (optical path La), travels straight, and exits from an emission point C5 of the flat surface 36b (optical path Lb). However, there is a certain limit in a margin for adjustment of the optical axis including other optical elements in the green color laser light source apparatus 2 (the optical axis adjustment margin is 0.5 mm, in this example). Therefore, in the installation structure of the comparative example, there is a case where it is difficult to perform an optical axis adjustment due to a lack of a margin for the optical axis adjustment because of a discrepancy W (the greatest value of W is 0.14 mm) between the laser light optical path La and the central axis X of the concave mirror 36.

The present invention is described based on a specific embodiment, however, these embodiments are merely shown as an example. The present invention is not limited by the embodiment. The laser light source apparatus of the present invention is suitable for a relatively small concave mirror. Thus, it is most suitable as a laser light source apparatus employed in a compact image display apparatus (projector) incorporated in a potable information processing device and the like (a drive bay of a laptop PC, for example). In addition, not all the components configuring the laser light source apparatus according to the present invention described in the embodiment above are necessarily required. The components may be appropriately selected as long as they are within the scope of the present invention.

It is noted that the foregoing examples have been provided merely for the purpose of explanation and are in no way to be construed as limiting of the present invention. While the present invention has been described with reference to exemplary embodiments, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular structures, materials and embodiments, the present invention is not intended to be limited to the particulars disclosed herein; rather, the present invention extends to all functionally equivalent structures, methods and uses, such as are within the scope of the appended claims.

The present invention is not limited to the above described embodiments, and various variations and modifications may be possible without departing from the scope of the present invention.

What is claimed is:

1. A laser light source apparatus comprising:
a semiconductor laser emitting excitation laser light;
a laser medium being excited by the excitation laser light and emitting infrared laser light;
a wavelength conversion element converting a wavelength of the infrared laser light and emitting harmonic laser light;
a concave mirror having a concave surface opposing the wavelength conversion element; and
a concave mirror supporter supporting the concave mirror,
wherein the concave mirror supporter has a mouth that transmits laser light from the wavelength conversion element toward the concave mirror, and a contacting surface that is in contact with the concave surface side of the concave mirror.

2. The laser light source apparatus according to claim 1, wherein the concave mirror supporter orthogonally intersects with an optical axis of the laser light from the wavelength conversion element and is provided to a surrounding area of one end side of the mouth.

3. The laser light source apparatus according to claim 1, wherein the concave mirror configures a resonator along with the laser medium through the wavelength conversion element.

4. The laser light source apparatus according to claim 1, wherein an outer surface of the concave mirror supporter is in contact with a peripheral edge of the concave surface side of the concave mirror.

5. The laser light source apparatus according to claim 1, further comprising:
an elastic pressing member pressing the concave mirror toward the contacting surface.

6. The laser light source apparatus according to claim 5, wherein the elastic pressing member is a flat spring; and
a pair of supporting arms is provided to an upper portion of the flat spring so as to have a space in-between, the pair of supporting arms being elastically deformable and being substantially L-shaped.

7. The laser light source apparatus according to claim 6, wherein the pair of supporting arms each has a tip that presses the concave minor toward the concave mirror supporter side.

8. The laser light source apparatus according to claim 7, wherein the pair of supporting arms each has an arc shaped contacting edge provided to a mutually opposing side, the contacting edges sandwiching a portion of a peripheral surface located in a middle in a height direction of the concave minor.

9. The laser light source apparatus according to claim 1, further comprising:
a base to which the concave minor supporter is provided,
wherein the base supports the wavelength conversion element and the laser medium together.

10. An image display apparatus comprising:
a laser light source apparatus according to claim 1;
a red color laser light source emitting red color laser light;
a blue color laser light source emitting blue color laser light, and
a projection optical unit projecting the laser light emitted from each of the laser light sources on a screen.
